(19) United States
(12) Patent Application Publication
(10) Pub. No.: US 2025/0358834 A1
(43) Pub. Date: Nov. 20, 2025

(54) PSSCH TRANSMISSION DIVERSITY ENHANCEMENTS FOR ROBUST SIDELINK

(71) Applicant: INTERDIGITAL PATENT HOLDINGS, INC., Wilmington, DE (US)

(72) Inventors: Joe Huang, Montville, NJ (US); Sudhir Pattar, Mount Laurel, NJ (US); Daniel Steinbach, Commack, NY (US); Phillip Leithead, King of Prussia, PA (US)

(73) Assignee: INTERDIGITAL PATENT HOLDINGS, INC., Wilmington, DE (US)

(21) Appl. No.: 18/666,516

(22) Filed: May 16, 2024

(51) Int. Cl. H04W 72/40; H04B 7/06; H04L 1/1812; H04W 28/26; H04W 72/25

(52) U.S. Cl. CPC H04W 72/40; H04B 7/0626; H04L 1/1812; H04W 28/26; H04W 72/25

(57) ABSTRACT

A wireless transmit receive unit (WTRU) and methods are disclosed for mitigating narrowband interference on sidelink communications. The method may include: receiving, at a WTRU, SCI, the SCI including information indicating at least one alternative TxRP different from the TxRP used for SCI is transmission, reserving, at the WTRU, resources on the at least one alternative TxRP according to the information indicated by the received SCI; and transmitting, by the WRTU, at least one of: a PSCCH, and a PSSCH, alone or in combination, via the reserved resources for a Hybrid Automatic Repeat Request HARQ transmission or HARQ retransmission, or a PSFCH for HARQ feedback, on the at least one alternative TxRP. The method may also include determining a rank of PSSCH transmission based on a CSI-RS, determining to apply PSSCH layer aggregation according to a channel quality when the determined rank is greater than 1.

### BACKGROUND

Recent trends are driving researchers to create more resilient solutions for 5G/6G wireless communications in the presence of high-power narrowband interferers, for example, in cases of spectrum sharing with incumbent government systems or against adversarial jamming. For example, a wireless communications system deployed in and around an airport may experience interference from RADAR. In another example, an external source may unintentionally or intentionally transmit a high-power narrowband that jams or interferes with WTRUs operating in the wireless communications system.

When a high-power narrowband interferer occurs in a band that overlaps with the RBs used by a WTRU involved in sidelink communication, for example 5G or 6G, to transmit over a PSCCH/PSSCH/PSFCH, the WTRU may not be able to reliably receive data radio bearer (DRB) and signaling radio bearer (SRB) traffic, as well as HARQ retransmissions. In addition, sidelink control information (SCI) is transmitted over the PSCCH and PSSCH channels. Therefore, the need exists for new mechanisms to ensure robust and efficient PSCCH/PSSCH/PSFCH transmission and reception can occur in the presence of high-power narrowband interferers.

### SUMMARY

Aspects, features and advantages of the disclosed embodiments ensure robust and efficient PSSCH transmission and reception in the presence of high-power narrowband interferers such as RADAR interference. Aspects and features may apply to a method of performing PSSCH transmission, the method may include: receiving, at a wireless transmit/receive unit (WTRU), Sidelink Control Information (SCI), the SCI including information indicating at least one alternative Transmit Resource Pool (TxRP) different from the TxRP the SCI is transmitted on, reserving, at the WTRU, resources on the at least one alternative TxRP according to the information indicated by the received SCI, and transmitting, by the WRTU, at least one of: a Physical Sidelink Control Channel (PSCCH), and a Physical Sidelink Shared Channel (PSSCH), alone or in combination, via the reserved resources for a Hybrid Automatic Repeat Request (HARQ) transmission or HARQ retransmission, or a Physical Sidelink Feedback Channel (PSFCH) for HARQ feedback, on the at least one alternative TxRP.

Aspects and features may apply to a WTRU including a receiver configured to receive SCI, the SCI including information indicating at least one alternative Transmit Resource Pool (TxRP) different from the TxRP the SCI is transmitted on, a processor configured to reserve resources on the at least one alternative TxRP according to the received SCI; and a transmitter configured to transmit at least one of: a Physical Sidelink Control Channel (PSCCH), and a Physical Sidelink Shared Channel (PSSCH), alone or in combination, via the reserved resources for a Hybrid Automatic Repeat Request (HARQ) transmission or HARQ retransmission, or a Physical Sidelink Feedback Channel (PSFCH) for a HARQ feedback on the at least one alternative TxRP.

In yet another aspect, features may apply to method of enhancing frequency diversity on sidelink transmission, the method may include allocating two or more exceptional Transmit Resource Pools (TxRPs) located distally from each other in a frequency domain, detecting a narrowband interferer, selecting at least one of the two or more exceptional TxRPs each time a Transport Block (TB) is to be transmitted, randomly selecting resources in the selected at least one of the two or more exceptional TxRPs, transmitting each of the TB via the selected resources, and informing a peer sidelink wireless transmit/receive unit (WTRU) and a corresponding network, either alone or in combination, of a transmitting WTRUs capability to support two or more TxRPs. The method may further include selecting at least one of the two or more exceptional TxRPs based on a detected frequency of the narrowband interferer or selecting randomly at least one of the two or more exceptional TxRPs.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is diagram depicting a potential scenario of a wireless network encountering interference from RADAR;

FIG. 2B is a diagram a potential scenario of a wireless network encountering interference from an adversarial source.

FIG. 3A is an illustration of resources in a TxRP;

FIG. 3B is an illustration of resources in an alternative TxRP;

FIG. 4 illustrates an exemplary serial mapping of two redundant versions of codewords to two MIMO layers;

FIG. 5 illustrates an exemplary parallel mapping of two redundant versions of codewords to two MIMO layers;

FIG. 6 is a flow diagram of an exemplary process of performing PSSCH transmission; and

FIG. 7 is a flow diagram of an exemplary enhancing frequency diversity on sidelink transmission.

### DETAILED DESCRIPTION

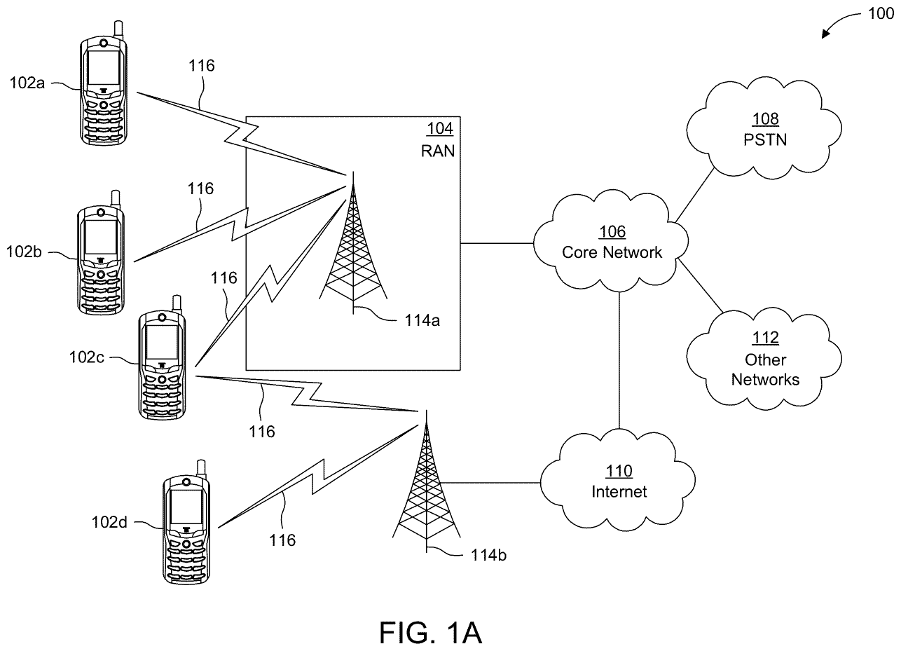

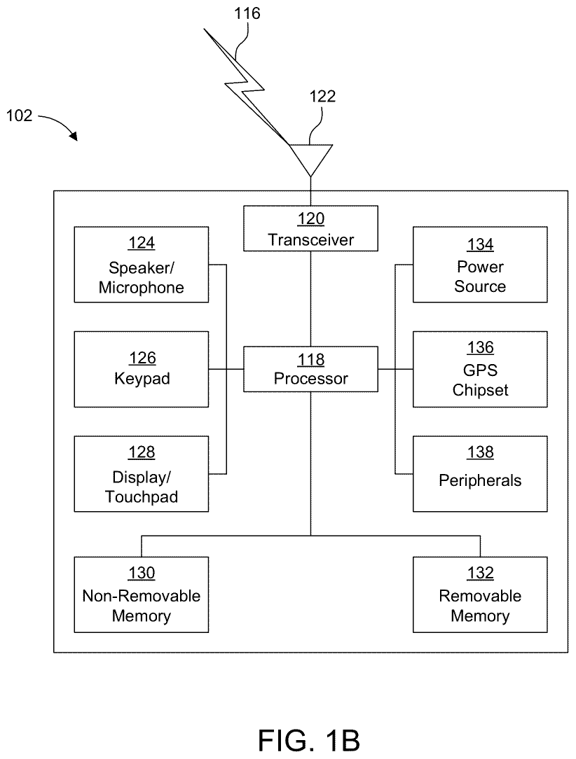

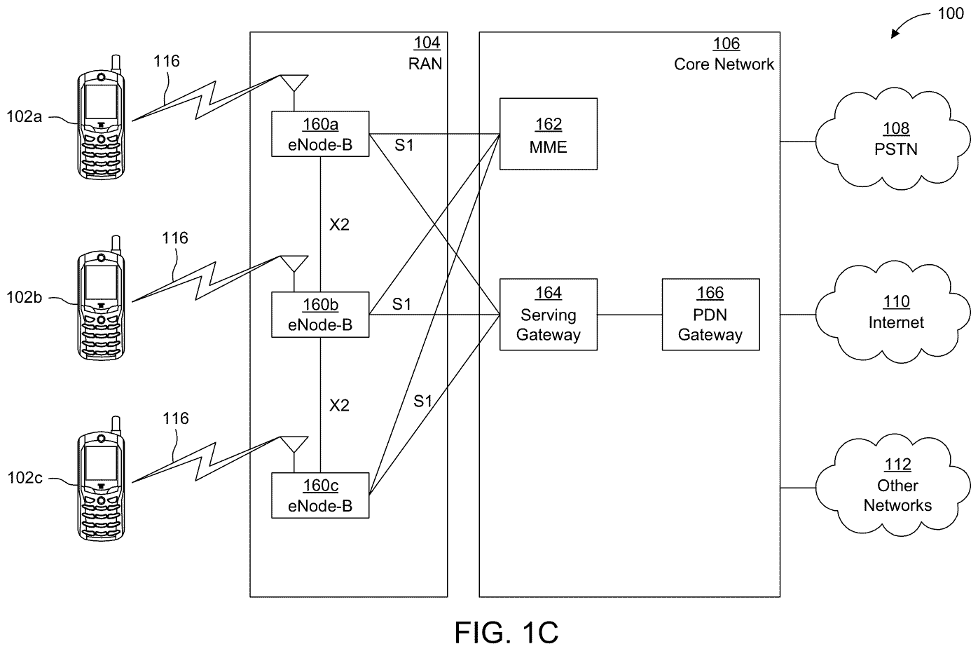

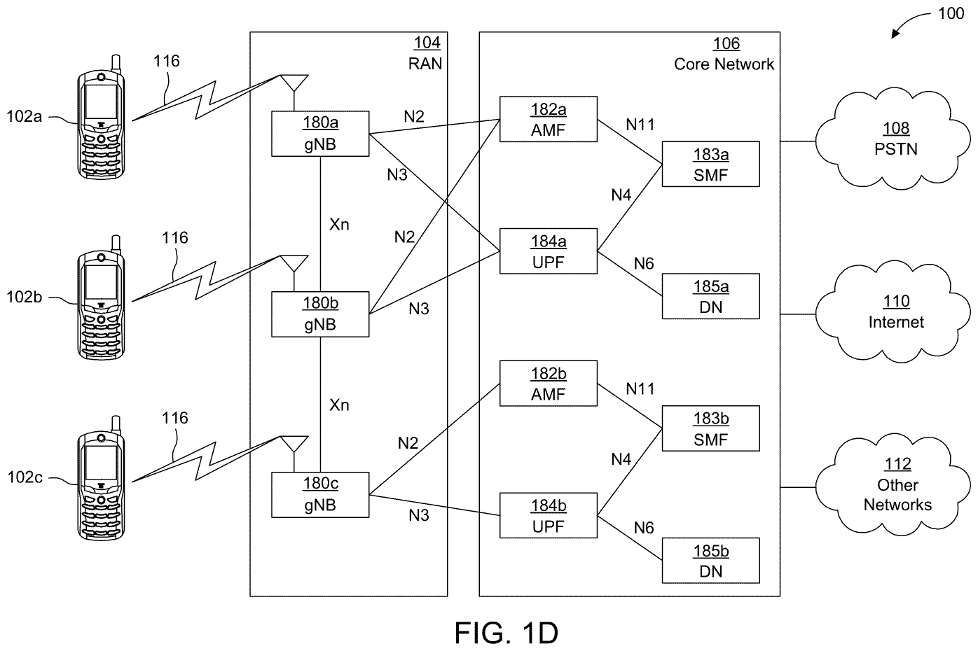

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR. NR is a radio access that may be used with 5G.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations may be referred to herein:
3GPP Third Generation Partnership Project
5G 5th Generation
AOA Angle of Arrival
BW Bandwidth
BWP Bandwidth Part
CG Configured Grant
CRC Cyclic Redundancy Check
C-RNTI Cell Specific Radio Network Temporary Identifier
CI-RNTI Cancellation Indicator Radio Network Temporary Identifier
CP-OFDM Cyclic Prefix OFDM
CS-RNTI Configured Scheduling Radio Network Temporary Identifier
CSI Channel State Information
DCI Downlink Control Information
DFT-S-OFDM Discrete Fourier Transform-Spread OFDM
DL Downlink
DMRS Demodulation Reference Signal
DRB Data Radio Bearer
eLCID Extended Logic Channel ID
eMTC Enhanced Machine Type Communication
ENSURED-5G Enhanced Security and Co-Existence for DoD-5G
FR1 Frequency Range 1
FR2 Frequency Range 2
gNB Next Generation (5G) NodeB
LCID Logic Channel ID
MAC Medium Access Control
MAC-CEMAC Control Element
MCS Modulation and Coding Scheme
MCS-C-RNTI Modulation and Coding Scheme Cell Specific Radio Network Temporary Identifier
NB-IoT Narrow Band Internet of Things
NDI New Data Indicator
NR New Radio
OFDM Orthogonal Frequency Division Multiplexing
PDCCH Physical Downlink Control Channel
PHY Physical Layer
PRACH Physical Random Access Channel
PRB Physical Resource Block
PSD Power Spectral Density
PUCCH Physical Uplink Control Channel
PUSCH Physical Uplink Shared Channel
QOS Quality of Service
RADAR Radio Detection and Ranging
RAR Random Access Response
RB Resource Block
RBG Resource Block Group
RE Resource Element
RIV Resource Indication Value
RRC Radio Resource Control
SCS Subcarrier Spacing
SLIV Start and Length Indicator Value
SRB Signaling Radio Bearer
TB Transport Block
TC-RNTI Temporary Cell Specific Radio Network Temporary Identifier
UCI Uplink Control Information
UE User Equipment
UL Uplink
URLLC Ultra Reliable Low Latency Communication
WTRU Wireless Transmit/Receive Unit
   . . .

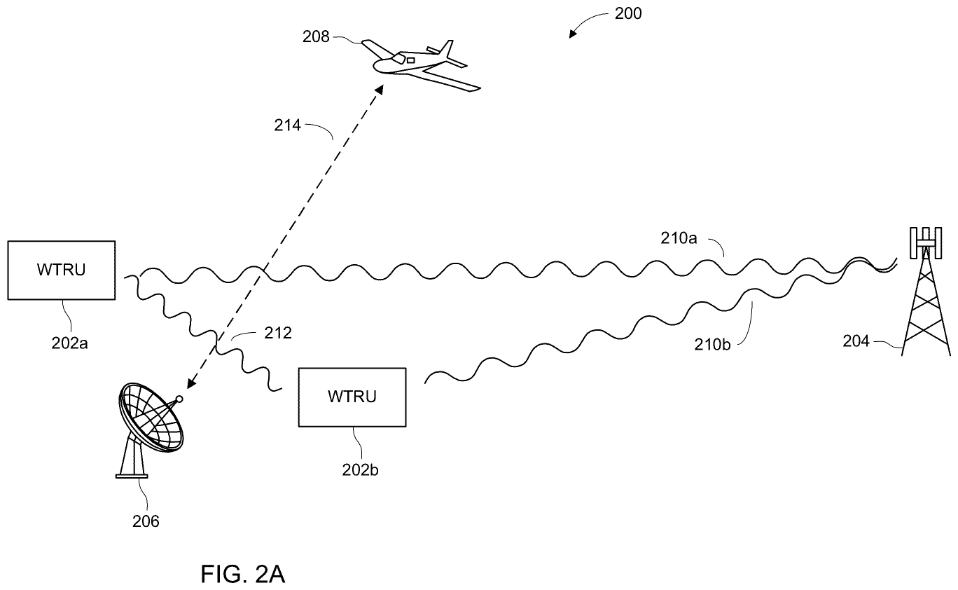

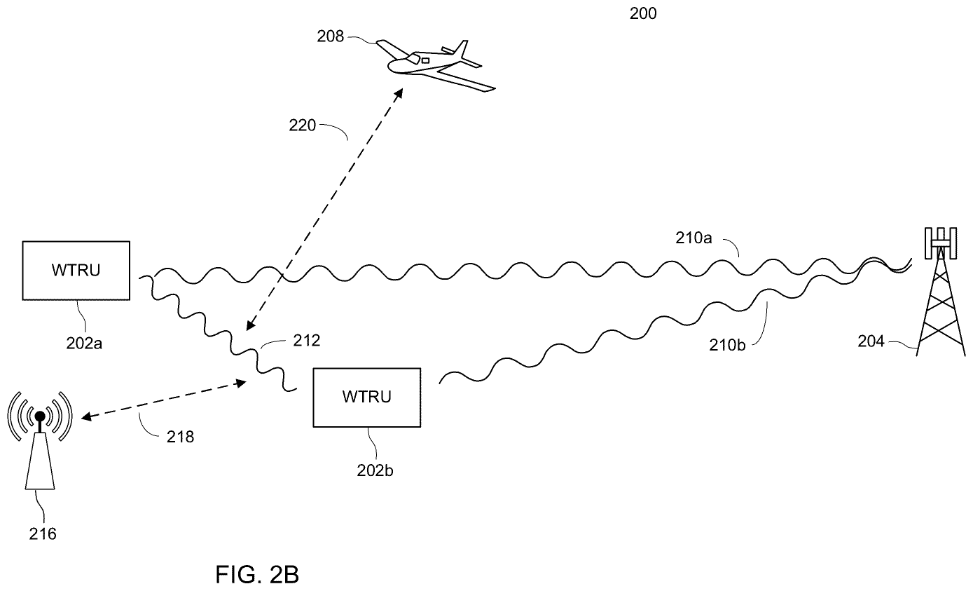

Referring to FIG. 2A, an example potential interference scenario 200 is shown where communications between a base station 204 and WTRU 202a may be adversely impacted by the presence of narrowband interferers, and where communication between WTRU 202a and WTRU 202b via wireless signal 210a may be adversely impacted by the presence of narrowband interferers, such as RADAR station 206 and/or RADAR on an aircraft 208 (or reflections therefrom). Wireless communication link 210a may experience interference from a RADAR emission/reception 214 transmitted and/or received from RADAR 206 or transmitted and/or received from aircraft 208.

The technological solutions discussed herein, will emphasize the interference on sidelink communication, for example wireless link 212 between WTRU 202a and WTRU 202b. Wireless communication link 212 may experience interference from a RADAR emission/reception 214 transmitted and/or received from RADAR 206 or transmitted and/or received from aircraft 208.

Referring to FIG. 2B, another example potential interference scenario 200 is shown where communications where communication between WTRU 202a and WTRU 202b via wireless signal 210a may be adversely impacted by the presence of narrowband interferers. In this example, narrow transmission 218 from transmitter 216 and narrowband transmission 220 from aircraft 208 may be intentional transmission intended to jam or interrupt side link communication link 212 between WTRU 202a and WTRU 202b. While the narrowband interferes 214 and 220 illustrated in FIGS. 2A and 2B show the potential interference of communication link 210a between a base station 204 and WTRU 202a, this is simply for ease of the illustration and may or may not be case depending on the location of the source of narrowband interference. The interference with communication link 210a should not be viewed as limiting. The source of narrowband interference may impact either of communication link 210a and communication link 210b, alone or in combination, and those skilled in the art should appreciate that these different scenarios are not essential to the PSSCH Transmission diversity enhancements for robust sidelink presented herein. Furthermore, scenarios exist where one or more of the WTRUs, for example WTRU 202a and/or WTRU 202b may be in coverage of a network, served for example by base station 204, in partial coverage of the network, or out of coverage of the network.

Sidelink communication is described herein. 5G NR sidelink may support three basic transmission scenarios. These include: unicast, in which case the sidelink transmission targets a specific receiving device, groupcast, in which case the sidelink transmission targets a specific group of receiving devices, and broadcast, in which case, the sidelink transmission targets any device that is within the range of transmission.

For unicast, a PC5-RRC connection is a logical connection between a pair of a Source Layer-2 ID and a Destination Layer-2 ID. The PC5-RRC signaling may be initiated after its corresponding PC5 unicast link establishment. The PC5-RRC connection and the corresponding sidelink SRBs and sidelink DRB(s) are released when the PC5 unicast link is released as indicated by upper layers. For each PC5-RRC connection of unicast, one sidelink SRB (i.e., SL-SRB0) is used to transmit the PC5-S message(s) before the PC5-S security has been established. One sidelink SRB (i.e., SL-SRB1) is used to transmit the PC5-S messages to establish the PC5-S security. One sidelink SRB (i.e., SL-SRB2) is used to transmit the PC5-S messages after the PC5-S security has been established, which is protected. One sidelink SRB (i.e., SL-SRB3) is used to transmit the PC5-RRC signaling, which is protected and only sent after the PC5-S security has been established.

There are two deployment scenarios for NR sidelink communication in terms of the relation between the sidelink communication and an overlaid cellular network. These deployment scenarios include: in-coverage operation, in which case the devices involved in the sidelink communication are under the coverage of an overlaid cellular network. The network can then, to a smaller or larger extent depending on the mode of sidelink resource allocation, control the sidelink communication, and out-of-coverage operation, in which case, the devices involved in the sidelink communication are not within the coverage of an overlaid cellular network.

In addition, there is also a “partial-coverage” scenario where only a subset of the devices involved in the device-to-device communication is within the coverage of an overlaid network. In the case of in-coverage operation, the sidelink communication may share carrier frequency with the overlaid cellular network. Alternatively, sidelink communication may take place on a sidelink specific carrier frequency different from the frequency of the cellular network.

A WTRU capable of NR sidelink communication that is in RRC_CONNECTED state may initiate a procedure to indicate it is (interested in) receiving or transmitting NR sidelink communication in several cases including: upon successful connection establishment or resuming, upon change of interest, upon changing QoS profiles, upon receiving UECapabilityInformationSidelink from the associated peer WTRU, upon RLC mode information update from the associated peer WTRU, or upon change to a PCell providing SIB12 including sl-ConfigCommonNR. A WTRU capable of NR sidelink communication may initiate the procedure to request assignment of dedicated sidelink DRB configuration and transmission resources for NR sidelink communication transmission. A WTRU capable of NR sidelink communication may initiate the procedure to report to the network that a sidelink radio link failure or sidelink RRC reconfiguration failure has been declared.

In general, a device under network coverage will be configured with a set of parameters needed for sidelink communication. Such parameters are at least partly needed for proper sidelink communication outside network coverage, in which case the parameters may, for example, be hard-wired into the device itself or stored on a device SIM card. This referred to as “pre-configuration,” to differentiate from the more conventional configuration taking place for devices under network coverage.

### Sidelink Resource Pool

When a device is configured for sidelink transmission, it is configured with a sidelink resource pool, which, among other things, defines the overall time/frequency resources that can be used for sidelink communication within a carrier. In the time domain, the resource pool consists of a set of slots repeated over a resource pool period. In the frequency domain, the resource pool consists of a set of consecutive subchannels, where a subchannel consists of a number of consecutive resource blocks. Overall, the time/frequency structure of a sidelink resource pool is thus defined by: a configurable resource pool period, a configurable set of sidelink slots within the resource pool period, a configurable subchannel bandwidth that may, for example, take the values 10, 15, 20, 25, 50, 75 and 100 resource blocks, a configurable resource pool bandwidth corresponding to a set of consecutive subchannels, and the frequency domain location of the first subchannel of the resource pool.

Although the resource pool configuration has a slot-based granularity in the time domain, this does not necessarily mean that all symbols of a sidelink slot are necessarily available for sidelink transmission. Rather, the network may impose limitations so that only a limited set of consecutive symbols within a sidelink slot is actually available for sidelink communication. This may be done by configuring the first symbol of the set of consecutive symbols available for sidelink communication, ranging from symbol number 0 to symbol number 7, and the number of consecutive symbols available for sidelink communication, ranging from 7 symbols to 14 symbols.

In this way, for example, it may ensure that the first and/or last few symbols of a slot are available for uplink and downlink control signaling in the case where sidelink communication shares a carrier with conventional downlink and uplink communication, for example in the case where sidelink communication is via communication link 210c. For a sidelink specific carrier, for example communication link 212 it may typically be assumed that all symbols within a sidelink slot are available for sidelink communication.

A resource pool (RP) may be shared by several WTRUs for their SL transmissions. An RP may be used for all transmission types (i.e., unicast, groupcast, and broadcast). A WTRU may be (pre-) configured with multiple RPs for transmission (transmit RPs) and with multiple RPs for reception (receive RPs). A WTRU may then receive data on resource pools used for SL transmissions by other WTRUs, while the WTRU can still transmit on the SL using its transmit resource pools. For the case when WTRUs in network coverage do not have a stable network connection, exceptional transmit RPs are configured for the WTRUs. These situations include when a WTRU is in a transition from idle to connected mode, when a WTRU experiences a link failure or a handover, or when a WTRU is changing between different configured transmit RPs. The use of exceptional transmit RPs in such situations aids in improving service continuity.

A WTRU may be provided via SL-BWP-Config a BWP (i.e., SL BWP) for SL transmissions with numerology and resource grid determined. For a resource pool within the SL BWP, the WTRU may be provided by sl-Num Subchannel a number of sub-channels where each sub-channel includes a number of contiguous RBs provided by sl-SubchannelSize. The first RB of the first sub-channel in the SL BWP is indicated by sl-StartRB-Subchannel. Available slots for a resource pool may be provided by sl-TimeResource and occur with a periodicity of 10240 ms. For an available slot without S-SS/PSBCH blocks, SL transmissions may start from a first symbol indicated by sl-StartSymbol and be within a number of consecutive symbols indicated by sl-LengthSymbols. For an available slot with S-SS/PSBCH blocks, the first symbol and the number of consecutive symbols are predetermined.

The WTRU may expect to use the same numerology in the SL BWP and in an active UL BWP in the same carrier of the same cell. If the active UL BWP numerology is different than the SL BWP numerology, the SL BWP is deactivated. The following parameters may be included in the sidelink BWP configuration.

The field sl-RxPool which indicates the receiving resource pool on the configured BWP. For the PSFCH related configuration, if configured, will be used for PSFCH transmission/reception. If the field is included, it replaces any previous list, i.e. all the entries of the list are replaced and each of the SL-ResourcePool entries is considered to be newly created. The field sl-TxPoolScheduling indicates the resources by which the WTRU is allowed to transmit NR sidelink communication based on network scheduling on the configured BWP. For the PSFCH related configuration, if configured, will be used for PSFCH transmission/reception. The field sl-DiscTxPoolScheduling indicates the resources by which the WTRU is allowed to transmit NR sidelink discover based on network scheduling on the configured BWP. For the PSFCH related configuration, if configured, will be used for PSFCH transmission/reception. When this field is configured together with sl-TxPoolScheduling, the resource pool index (which is used in DCI Format 3_0) is defined as 0, 1, . . . , x−1 for the resource pools included in the sl-TxPoolScheduling, and x, x+1, . . . , x+y−1 for the resource pools included in sl-DiscTxPoolScheduling, where x is the number of the resource pools in sl-TxPoolScheduling, and y is the number of resource pools in sl-DiscTxPoolScheduling. The field sl-TxPoolSelectedNormal indicates the resources by which the WTRU is allowed to transmit NR sidelink communication by WTRU autonomous resource selection on the configured BWP. For the PSFCH related configuration, if configured, will be used for PSFCH transmission/reception. The field sl-TxPoolExceptional indicates the resources by which the WTRU is allowed to transmit NR sidelink communication in exceptional conditions on the configured BWP. For the PSFCH related configuration, if configured, will be used for PSFCH transmission/reception. The field sl-TimeResource indicates the bitmap of the resource pool, which is defined by repeating the bitmap with a periodicity during a SFN or DFN cycle.

### Side Link Channels

Similar to downlink and uplink transmissions, sidelink transmission takes place over a set of physical channels onto which a transport channel is mapped and/or which L1/L2 control signaling is carried. These channels may include the PSSCH, PSCCH and PSFCH.

The PSSCH is a channel onto which the Sidelink Shared Channel (SL-SCH) transport channel is mapped. In other words, the PSSCH carries the actual sidelink data between devices. Thus, it serves a similar purpose as the PDSCH for downlink communication. In contrast to PDSCH, the PSSCH also controls some L1/L2 signaling that is referred to as the 2^{nd} stage SCI (or SCI format 0_2).

The PSCCH carries sidelink control information (SCI), referred to as the 1^{st}-stage SCI (or SCI format 0_1). The 1^{st}-stage SCI includes information needed by receiving devices for proper demodulation/detection of the PSSCH. Thus, the PSCCH serves a similar purpose as the PDCCH carrying downlink control information (DCI) needed by a receiving device for proper demodulation/detection of the PDSCH. The 1^{st}-stage SCI also includes information related to resource reservation. This information is relevant for devices operating under resource allocation mode 2. Thus, even if the sidelink data transmission is unicast, the 1^{st}-stage SCI has to be broadcast with a known format.

The PSFCH carries sidelink HARQ feedback from a receiving device to the transmitting device. Thus, the PSFCH serves a similar purpose as PUCCH when used to carry uplink Hybrid-HARQ feedback related to downlink data transmission. It is noted that if PSFCH resources are configured for a sidelink slot, a total of three symbols will be used, including the AGC symbol and an extra guard symbol, with a corresponding reduction in the number of symbols available for PSSCH transmission. There does not have to be PSFCH resources in every slot. A resource pool can be configured to have PSFCH resources in every slot, in every second slot, or in every fourth slot. A resource pool can also be configured without any PSFCH resources in which case HARQ will not be used for sidelink transmission within the resource pool.

### Sidelink Resource Allocation

There are two basic modes for sidelink communication in terms of how the exact set of resources to use for sidelink transmission is decided. In the case of resource allocation mode 1, an overlaid network schedules the sidelink transmissions. Resource allocation mode 1 is thus only applicable for the in-coverage or partial-coverage deployment scenarios. In the case of resource allocation mode 2, a decision on sidelink transmission, including on the exact of resources to use for the transmission, is made by the transmitting device itself based on a sensing and resource selection procedure. Resource allocation mode 2 is applicable to both in-coverage and out-of-coverage deployment scenarios.

The resource allocation mode is relevant only from a transmitter point of view and a receiving device does not need to know under what resource allocation mode the transmitting device is operating. Also, a receiving device may very well operate under a different resource allocation mode for its own sidelink transmission. Therefore, even if a certain device carries out sidelink transmission based on resource allocation mode 1, it still has to provide the resource reservation information needed by other devices for the sensing and resource selection procedure associated with resource allocation mode 2.

In the case of resource allocation mode 1, sidelink (PSSCH/PSCCH) transmissions can only be carried out by a device if the device has been provided with a valid scheduling grant that indicates the exact set of resources to be used for transmission. This is similar to the scheduling of uplink transmissions with the important difference that the grant is for a sidelink transmission rather than an uplink transmission. Also similar to uplink scheduling, sidelink scheduling can be done by means of both dynamic and configured grants.

A dynamic grant for sidelink transmission is provided by means of a new DCI format 3_0. Each dynamic grant can schedule resources for the transmission of the same transport block (TB) in up to three different slots within a window of 32 slots. The first scheduled resource occurs at a time offset AT after the slot within which the DCI carrying the scheduling grant is received. The remaining up to two scheduled resources have time offsets ΔT₁ and ΔT₂ relative to the first scheduled resource. The up to three resources have the same bandwidth but may have different frequency locations given by the frequency offsets Δf, Δf₁ and Δf₂, where Δf, Δf₁ and Δf₂ are the frequency offsets of the first, second and third scheduled resource relative to the start of the resource pool. The parameters ΔT, ΔT₁ and ΔT₂, and Δf, Δf₁ and Δf₂, as well as the bandwidth of the scheduled resource are provided within the scheduling DCI.

A configured grant provides a periodically occurring grant for sidelink transmission. Similar to uplink scheduling, there are two types of configured grant for sidelink transmission. Configured grant type 1, for which the entire grant, including the resources to use for sidelink transmission is configured by means of RRC signaling. Configured grant type 2, for which the periodicity is configured by means of RRC signaling while activation of the grant, as well as the periodic resources to use for sidelink transmission, is provided by DCI format 3_0 using an RNTI different from the one used for dynamic grants. For each period, the configured grant (both type 1 and type 2) may provide resources in up to three slots similar to a dynamic grant.

DCI format 3_0 is used for scheduling of NR PSCCH and NR PSSCH in one cell. The following information is transmitted by means of the DCI format 3_0 with CRC scrambled by SL-RNTI or SL-CS-RNTI:
Resource pool index −┌log₂ I┐ bits, where/is the total number of resource pools for transmission configured by the higher layer parameter sl-TxPoolScheduling, if configured, and sl-DiscTxPoolScheduling, if configured;
Time gap (3 bits) determined by higher layer parameter sl-DCI-ToSL-Trans;
HARQ process number (4 bits);
New data indicator (1 bit);
SCI format 1-A fields, which may include a frequency resource assignment, and a time resource assignment, PSFCH-to-HARQ feedback timing indicator −┌log₂ N_{fb_timing}┐ bits, where N_{fb_timing} is the number of entries in the higher layer parameter sl-PSFCH-ToPUCCH;
PUCCH resource indicator (3 bits);
Configuration index (0 bit) if the WTRU is not configured to monitor DCI format 3_0 with CRC scrambled by SL-CS-RNTI; otherwise (3 bits). If the WTRU is configured to monitor DCI format 3_0 with CRC scrambled by SL-CS-RNTI, this field is reserved for DCI format 3_0 with CRC scrambled by SL-RNTI;
Counter sidelink assignment index (2 bits) including 2 bits if the WTRU is configured with pdsch-HARQ-ACK-Codebook=dynamic and 2 bits if the WTRU is configured with pdsch-HARQ-ACK-Codebook=semi-static; and
Padding bits if required.

In the case of resource allocation mode 2, a device autonomously decides on sidelink transmissions, including deciding on the exact resources to use for the transmissions, based on a sensing and resource selection procedure. The sensing and resource selection procedure is assisted by the resource reservation announcements, the intention of which is to provide information to other devices about what set of resources a device has selected for future sidelink transmissions. The other devices will then use this information as part of the sensing and resource selection procedure, that is, when selecting the set of resources they themselves will use/reserve for future sidelink transmissions. The resource reservation information is announced to other devices as part of the 1^{st}-stage SCI.

### Resource Reservation

In addition to the PSSCH/PSCCH transmission of the current slot, that is, the slot in which the 1^{st}-stage SCI is transmitted, a device can reserve up to two additional PSSCH/PSCCH transmissions within a time window of 32 slots (including the current slot). Each of these two transmissions has the same bandwidth as the transmission of the current slot but can have different frequency domain locations. Information about these reserved resources, defined by the time offsets ΔT₁ and ΔT₂ and the subchannel frequency offsets Δf₁ and Δf₂ as well as information about the bandwidth of the reserved resources (same bandwidth of the initial transmission), is provided as part of the resource reservation within the 1^{st}-stage SCI.

It is noted that the structure of these up to three resources (current resource plus up to two additional reserved resources) is the same as the up to three scheduled resources that can be provided by means of a dynamic or configured grant in resource allocation mode 1. Also note that the parameters ΔT₁, ΔT₂, Δf₁ and Δf₂ are embedded in the 1^{st}-stage SCI even though the transmitting device operates under resource allocation mode 1. A receiving device operating under resource allocation mode 2 will then interpret the corresponding resources as reserved when carrying out the sensing and resource allocation procedure.

To be more specific, the set of slots and resource blocks for PSSCH transmission is determined by the resource used for the PSCCH transmission containing the associated SCI format 1-A, and fields ‘Frequency resource assignment’, ‘Time resource assignment’ of the associated SCI format 1-A. ‘Time resource assignment’ carries logical slot offset indication of N=1 or 2 actual resources when sl-MaxNumPerReserve is 2, and N=1, 2 or 3 actual resources when sl-MaxNumPerReserve is 3, in a form of time RIV (TRIV) field which is determined as follows:

```
  If N = 1
    TRIV = 0
elseif N = 2
    TRIV = t₁
else
    if (t₂ − t₁ − 1) ≤ 15
      TRIV = 30(t₂ − t₁ − 1) + t₁ + 31
    else
      TRIV = 30(31 − t₂ + t₁) + 62 − t₁
    end if
end if
```

Where the first resource is in the slot where SCI format 1-A was received, and tᵢ denotes i-th resource time offset in logical slots of a resource pool with respect to the first resource where for N=2, 1≤t₁≤31; and for N=3, 1≤t₁≤30, t₁<t₂≤31.

The starting sub-channel n_{subCH,0}^{start} of the first resource may be determined using “Frequency resource assignment” field in the associated SCI. The lowest sub-channel for sidelink transmission is the sub-channel on which the lowest PRB of the associated PSCCH is transmitted. The lowest index of the RB set allocation to the initial PSSCH transmission is indicated via the field “Lowest index of the RB set allocation to the initial transmission” of the DCI format 3_0, and the starting RB set index of the initial PSSCH transmission of the sidelink configured grant Type 1 is indicated via the higher layer parameter sl-StartRBsetCG-Type1. The number of contiguously allocated sub-channels for each of the N resources L_{subCH}>1 and the starting sub-channel indexes of resources indicated by the received SCI format 1-A, except the resource in the slot where SCI format 1-A was received, are determined from “Frequency resource assignment” which is equal to a frequency RIV (FRIV) where: if sl-MaxNumPerReserve is 2 then

$$FRIV = {n}_{subCH , 1}^{start} + {\sum }_{i = 1}^{{L}_{subCH} - 1} ( {N}_{subchannel}^{SL} + 1 - i )$$

If sl-MaxNumPerReserve is 3 then

$$FRIV = {n}_{subCH , 1}^{start} + {n}_{subCH , 2}^{start} \cdot ( {N}_{subchannel}^{SL} + 1 - {L}_{subCH} ) + {\sum }_{i = 1}^{{L}_{subCH} - 1} {( {N}_{subchannel}^{SL} + 1 - i )}^{2}$$

Where n_{subCH,1}^{start} denotes the starting sub-channel index for the second resource, n_{subCH,2}^{start} denotes the starting sub-channel index for the third resource, and N_{subchannel}^{SL} is the number of sub-channels in a resource pool provided according to the higher layer parameter sl-NumSubchannel.

If TRIV indicates N<sl-MaxNumPerReserve, the starting sub-channel indexes corresponding to sl-MaxNumPerReserve minus N last resources are not used.

In addition to the described one or two reserved resources within a time window of 32 slots, it is also possible to reserve periodically occurring set of resources for the transmission of additional data (i.e., additional transport blocks). Each such periodically occurring set of resources has the same structure (bandwidth, frequency shifts, and relative time offsets) as the initial set of up to three resources and are periodically occurring with a resource reservation period (Tₚ), which can range from as small as 1 ms to as large as 1000 ms. As part of the resource pool configuration, devices are provided with up to 15 possible values of Tₚ. A device may then select one of these values and announce it in form of a four-bit parameter as part of the resource reservation within the 1^{st} stage SCI. The remaining (all-zero) parameter value is used to indicate that no periodic resources are reserved. Also noted is that devices operating under resource allocation mode 1 should always signal the all-zero parameter value within the 1^{st}-stage SCI.

### Sensing

The sensing procedure is the procedure by which a device operating under resource allocation mode 2 selects the set of resources to use for sidelink transmission based on, among other things, resource reservations announced by other devices. The data to be transmitted are assumed to require a certain amount of frequency domain resources (i.e., a certain number of subchannels). It is also assumed to have a certain delay budget, implying that the data should be transmitted within a certain time window. The transmission is also assumed to have a certain priority. The sensing algorithm starts by the device listing all potential candidate resources, which is the same as all N-subchannel resources within the resource pool bandwidth for all sidelink slots within a reservation window, where N is the required amount of frequency domain resources (note that there is a total of (M−N+1) N-subchannel resources within a slot, where M is the overall resource pool bandwidth measured in subchannels). The reservation window is limited by the assumed delay budget for the data to be transmitted.

Based on the 1^{st}-stage SCI transmissions of other devices received during a preceding sensing window, the device is assumed to have acquired knowledge about the resource reservations announced by other devices. If a resource in the list of potential candidate resources partly overlaps with a resource reserved by another device and the transmission of that device was received with a signal strength (RSRP) that exceeds a configured threshold, the resource is removed from the list of potential candidate resources. The threshold with which the RSRP is compared depends on: the priority of the transmission to be made by the sensing, and the priority of the announced resource reservation, information about which is provided as part of the resource reservation information within the 1^{st} stage SCI.

If at the end of this procedure, the remaining list of potential candidate resources contains less than a certain percentage of resources, for example 20%, (as configured by sl-TxPercentage) of the original list, that is, more than 80% of the original potential candidate resources have been removed from the list, the procedure is restarted with the RSRP thresholds increased by 3 dB. This will reduce the probability that a resource will be removed from the list of potential candidate resources, that is, increase the number of remaining candidate resources. This is repeated, with further increased thresholds until the remaining set of candidate resources includes at least 20% of the resources of the original set. The final set of resources is then selected at random from this remaining set of candidate resources.

To summarize, the sensing procedure performs the following: prioritize resources not reserved by other devices; prioritize resources reserved by other devices received with lower RSRP, with aim to reduce the impact of any collision due to the use of the same resource for sidelink transmissions by nearby devices while allowing for spatial reuse of the resources by devices at a larger distance away; prioritize resource reserved with a lower relative priority by other devices, that is, prioritize resources for which a collision may be less critical; and guarantee that there are at least 20% of the original potential candidate resources within the delay budget time window to do the final random resource selection from

The parameters that may be required to for the sending procedure may include: sl-TxPercentageList which indicates the portion of candidate single-slot PSSCH resources over the total resources, for example, a value p20 corresponds to 20%, and so on; sl-PrioritizationThres which indicates the SL priority threshold, which is used to determine whether SL TX is prioritized over UL TX; sl-ProbResourceKeep which indicates the probability with which the WTRU keeps the current resource when the resource reselection counter reaches zero for sensing-based WTRU autonomous resource selection; and ul-PrioritizationThres which indicates the UL priority threshold, which is used to determine whether SL TX is prioritized over UL TX. It is noted that the network does not configure the sl-PrioritizationThres and the ul-PrioritizationThres to the WTRU separately.

### Sidelink Control Information.

In NR SL, data is organized into transport blocks (TBs) and each TB is associated with a sidelink control information (SCI). A TB is carried in a PSSCH. The SCI indicates the resources used by the PSSCH that carries the associated TB, as well as further information required for decoding the TB. A PSCCH is sent with a PSSCH. The SCI in NR SL is transmitted in two stages compared to a single stage for LTE SL. The 1^{st}-stage SCI in NR SL is carried on the PSCCH while the 2^{nd}-stage SCI is carried on the corresponding PSSCH. The introduction of the 2^{nd}-stage SCI enables a flexible SCI design to support unicast, groupcast, and broadcast transmissions in NR SL, in contrast to LTE SL where only broadcast is supported. Splitting the SCI in two stages (1^{st}-stage SCI and 2^{nd}-stage SCI) allows other WTRUs which are not RX WTRUs of a transmission to decode only the 1^{st}-stage SCI for channel sensing purposes, i.e., for determining the resources reserved by other transmissions. On the other hand, the 2^{nd}-stage SCI provides additional control information which is required for the RX WTRU(s) of a transmission.

### WTRU Procedure for Transmitting PSCCH

The PSCCH is multiplexed in non-overlapping resources with the associated PSSCH in the same slot. The PSCCH is transmitted from the second SL symbol in the slot and starting from the lowest PRB within the sub-channel(s) occupied by the associated PSSCH. The number of symbols for the PSCCH is (pre-) configured per resource pool and can be equal to 2 or 3 symbols. In the frequency domain, the PSCCH occupies a (pre-) configurable number M_{PSCCH} of PRBs per resource pool that can be equal to 10, 12, 15, 20 or 25 PRBs. However, as the PSCCH is to be contained within one sub-channel, the number M_{PSCCH} of PRBs for the PSCCH is limited by the number M_{sub} of PRBs in a sub-channel, i.e., M_{PSCCH}<M sub. The possible number of symbols and PRBs for PSCCH allow different allocations of PSCCH in the time and frequency domain. For instance, for a large sub-channel size (e. g., M_{sub}=75 PRBs), the PSCCH can occupy a large number of PRBs (i.e., M_{PSCCH}=25 PRBs), and hence 2 symbols for the PSCCH may suffice. On the other hand, for a smaller sub-channel size (e.g., M_{sub}=15 PRBs), the PSCCH may only be able to occupy M_{PSCCH}=10 or 12 PRBs and thus, the PSCCH may need to use 3 symbols.

A WTRU may be provided a number of symbols in a resource pool, by sl-TimeResourcePSCCH, starting from a second symbol that is available for SL transmissions in a slot, and a number of PRBs in the resource pool, by sl-FreqResourcePSCCH, starting from the lowest PRB of the lowest sub-channel of the associated PSSCH, for a PSCCH transmission with a SCI format 1-A.

### Sidelink Control Information on PSCCH

SCI carried on PSCCH is a 1^{st}-stage SCI, which transports sidelink scheduling information. A priority of a PSSCH according to NR radio access or according to E-UTRA radio access is indicated by a priority field in a respective scheduling SCI format. A priority of a PSFCH is same as the priority of a corresponding PSSCH. The 1^{st}-stage SCI also provides the number of ports of the PSSCH DMRS, which can be equal to one or two. This represents the number of layers (i.e., number of data streams) supported in the PSSCH. Thus, by exploiting multiple transmit and receive antennas up to two streams of data can be sent within a PSSCH in NR SL.

### SCI Format 1-A

SCI format 1-A is used for the scheduling of PSSCH and 2^{nd}-stage SCI on PSSCH. The following information is transmitted by means of the SCI format 1-A:
Priority (3 bits). Value ‘000’ of Priority field corresponds to priority value ‘1’, value ‘001’ of Priority field corresponds to priority value ‘2’, and so on;

$$Frequency resource assignment - ⌈ {log}_{2} ( \frac{{N}_{subChannel}^{SL} ( {N}_{subChannel}^{SL} + 1 )}{2} ) ⌉ bits$$

when the value of the higher layer parameter sl-MaxNumPerReserve is configured to 2; otherwise

$$⌈ {log}_{2} ( \frac{{N}_{subChannel}^{SL} ( {N}_{subChannel}^{SL} + 1 ) ( 2 {N}_{subChannel}^{SL} + 1 )}{2} ) ⌉ bits$$

when the value of the higher layer parameter sl-MaxNumPerReserve is configured to 3;
Time resource assignment (5 bits) when the value of the higher layer parameter sl-MaxNumPerReserve is configured to 2; otherwise 9 bits when the value of the higher layer parameter sl-MaxNumPerReserve is configured to 3;
Resource reservation period −┌log₂ N_{rsv_period}┐ bits, where N_{rsv_period} is the number of entries in the higher layer parameter sl-ResourceReservePeriodList, if higher layer parameter sl-MultiReserveResource is configured; 0 bit otherwise.
DMRS pattern −┌log₂ Nₚₐₜₜₑᵣₙ┐ bits, where Nₚₐₜₜₑᵣₙ is the number of DMRS patterns configured by higher layer parameter sl-PSSCH-DMRS-TimePatternList,
2^{nd}-stage SCI format (2 bits) as defined in Table 1;

TABLE 1

| Value of 2nd-stage SCI format field | 2nd-stage SCI format |
|---|---|
| 00 | SCI format 2-A |
| 01 | SCI format 2-B; or |
| | reserved if higher layer parameter |
| | transmissionStructureForPSCCHandPSSCH in SL- |
| | BWP-Config is configured |
| 10 | SCI format 2-C; or |
| | reserved if higher layer parameter |
| | transmissionStructureForPSCCHandPSSCH in SL- |
| | BWP-Config is configured and the COT sharing flag |
| | field is set to ‘1’ |
| 11 | SCI format 2-D; or |
| | reserved if higher layer parameter |
| | transmissionStructureForPSCCHandPSSCH in SL- |
| | BWP-Config is configured |

Beta_offset indicator (2 bits) as provided by higher layer parameter sl-BetaOffsets2ndSCI and Table 2;

TABLE 2

| Value of Beta offset indicator | Beta_offset index |
|---|---|
| 00 | 1st index provided by higher layer parameter sl-BetaOffsets2ndSCI |
| 01 | 2nd index provided by higher layer parameter sl-BetaOffsets2ndSCI |
| 10 | 3rd index provided by higher layer parameter sl-BetaOffsets2ndSCI |
| 11 | 4th index provided by higher layer parameter sl-BetaOffsets2ndSCI |

Number of DMRS port (1 bit) as defined in Table 3;

TABLE 3

| Value of the Number of DMRS port field | Antenna ports |
|---|---|
| 0 | 1000 |
| 1 | 1000 and 1001 |

Modulation and coding scheme (5 bits);
Additional MCS table indicator (1 bit) if one MCS table is configured by higher layer parameter sl-Additional-MCS-Table; (2 bits) if two MCS tables are configured by higher layer parameter sl-Additional-MCS-Table; (0 bit) otherwise;
PSFCH overhead indication (1 bit) as defined clause 8.1.3.2 of TS 38.214 if higher layer parameter sl-PSFCH-Period=2 or 4; (0 bit) otherwise;
Reserved, here a number of bits as determined by the following: N_{reserved} bits as configured by higher layer parameter sl-NumReservedBits, with value set to zero, if higher layer parameter sl-IndicationUE-B is not configured, or if higher layer parameter sl-IndicationUE-B is configured to ‘disabled’, and (N_{reserved}−1) bits otherwise, with value set to zero; and
Conflict information receiver flag may be (0 or 1 bit), 1 bit if higher layer parameter sl-IndicationUE-B is configured to ‘enabled’, where the bit value of 0 indicates that the WTRU cannot be a WTRU to receive conflict information and the bit value of 1 indicates that the WTRU can be a WTRU to receive conflict information, 0 bit otherwise.

### Sidelink Control Information on PSSCH

SCI carried on PSSCH is a 2^{nd}-stage SCI, which transports sidelink scheduling information, and/or inter-WTRU coordination related information. The 2^{nd}-stage SCI only contains information of relevance to the device or group of devices for which the actual sidelink data transmission is intended. This includes, for example, a destination ID, that is, the identity of the device or group of devices for which the sidelink data transmission is intended, and information related to HARQ. Furthermore, the format of the 2^{nd}-stage SCI can be variable as it is signaled within the 1^{st}-stage SCI. Thus the 2^{nd}-stage SCI can be beamformed and its format can be adjusted to match the channel conditions of the device(s) that is/are the actual target(s) of the sidelink data transmission. In addition, SL-SCH supports the transmission of one transport block over up to two layers. In case of two-layer transmission, for the 2^{nd}-stage SCI, which relies on the same DM-RS as SL-SCH, the same symbol is mapped to both antenna ports.

### SCI Format 2-A

SCI format 2-A is used for the decoding of PSSCH, with HARQ operation when HARQ-ACK information includes ACK or NACK, when HARQ-ACK information includes only NACK, or when there is no feedback of HARQ-ACK information. The following information is transmitted via the SCI format 2-A:
HARQ process number (4 bits), New data indicator (1 bit);
Redundancy version (2 bits) as defined in Table 4;

TABLE 4

| Value of the Redundancy | Value of rv_{id} to |
|---|---|
| version field | be applied |
| 00 | 0 |
| 01 | 1 |
| 10 | 2 |
| 11 | 3 |

Source ID (8 bits);
Destination ID (16 bits);
HARQ feedback enabled/disabled indicator (1 bit);
Cast type indicator (2) bits as defined in Table 5; and
CSI request (1 bit).

TABLE 5

| Value of Cast type | |
|---|---|
| indicator | Cast type |
| 00 | Broadcast |
| 01 | Groupcast |
| | when HARQ-ACK information |
| | includes ACK or NACK |
| 10 | Unicast |
| 11 | Groupcast when HARQ-ACK |
| | information includes only NACK |

### SCI Format 2-B

SCI format 2-B is used for the decoding of PSSCH, with HARQ operation when HARQ-ACK information includes only NACK, or when there is no feedback of HARQ-ACK information. The following information is transmitted by means of the SCI format 2-B: HARQ process number (4 bits); New data indicator (1 bit); Redundancy version (2 bits) as defined in Table 4; Source ID (8 bits); Destination ID (16 bits); HARQ feedback enabled/disabled indicator (1 bit); Zone ID (12 bits); and Communication range requirement (4 bits) determined by higher layer parameter sl-ZoneConfigMCR-Index.

### SCI Format 2-C

SCI format 2-C is used for the decoding of PSSCH and providing inter-UE coordination information or requesting inter-UE coordination information. SCI format 2-C can be used only for unicast. The following information is transmitted by means of the SCI format 2-C: HARQ process number (4 bits) New data indicator (1 bit); Redundancy version (2 bits) as defined in Table 4; Source ID (8 bits); Destination ID (16 bits); HARQ feedback enabled/disabled indicator (1 bit); CSI request (1 bit); and Providing/Requesting indicator (1) bit where value 0 indicates SCI format 2-C is used for providing inter-UE coordination information and value 1 indicates SCI format 2-C is used for requesting inter-UE coordination information.

If the ‘Providing/Requesting indicator’ field is set to 0, all the remaining fields are set as follows:

$$Resource combinations - 2 \cdot ( ⌈ {log}_{2} ( \frac{{N}_{subChannel}^{SL} ( {N}_{subChannel}^{SL} + 1 ) ( 2 {N}_{subChannel}^{SL} + 1 )}{6} ) ⌉ + 9 + Y ) bits ,$$

where Y=┌log₂ N_{rsv_period} ┐ and N_{rsv_period} is the number of entries in the higher layer parameter sl-ResourceReservePeriodList, if higher layer parameter sl-MultiReserveResource is configured; Y=0 otherwise, N_{subChannel}^{SL} is the number of subchannels in a resource pool provided by the higher layer parameter sl-NumSubchannel; First resource location (8 bits); Reference slot location −(10+┌log (10·2^{μ})┐) bits, where u is defined in Table 6; Resource set type (1 bit), where value 0 indicates preferred resource set and value 1 indicates non-preferred resource set; and Lowest subChannel indices 2·┌log₂ N_{subChannel}^{SL}┐ bits.

TABLE 6

| μ | Δƒ = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

If the ‘Providing/Requesting indicator’ field is set to 1, all the remaining fields are set as follows:

Priority (3 bits). where value ‘000’ of Priority field corresponds to priority value ‘1’, value ‘001’ of Priority field corresponds to priority value ‘2’, and so on; Number of subchannels −┌log₂ N_{subChannel}^{SL}┐; Resource reservation period-┌log₂ N_{rsv_period}┐ bits, where N_{rsv_period} is the number of entries in the higher layer parameter sl-ResourceReservePeriodList, if higher layer parameter sl-MultiReserveResource is configured, 0 bit otherwise; Resource selection window location −2·(10+┌log₂(10·2^{μ})┐) bits, where u is defined in Table 6; Resource set type (1 bit), where value 0 indicates a request for inter-WTRU coordination information providing preferred resource set and value 1 indicates a request for inter-WTRU coordination information providing non-preferred resource set, if higher layer parameter sl-DetermineResourceType is configured to ‘ueb’, otherwise, 0 bit; and Padding bits.

For operation in a same resource pool, zeros shall be appended to SCI format 2-C of which ‘Providing/Requesting indicator’ field is set to 1 until the payload size equals that of SCI format 2-C of which ‘Providing/Requesting indicator’ field is set to 0.

### Sidelink Channel Sounding and CSI Reporting

NR sidelink supports sidelink channel state information (CSI) reporting where a receiving device sounds the channel based on CSI-RS transmitted by another device and reports CSI to the transmitting device. The reported CSI can then be used, for example, for selection of precoding for subsequent transmissions to the reporting device. The sidelink CSI-RS structure reuses the structure of the downlink CSI-RS, with the following restrictions: the number of CSI-RS ports is limited to one or two, and the CSI-RS density is limited to one, that is, CSI-RS is transmitted within every resource within the sidelink transmission bandwidth.

Sidelink CSI-RS is only transmitted together with PSSCH/PSCCH (aperiodic transmissions) and the presence of CSI-RS within PSSCH and PSCCH is indicated within the 2^{nd}-stage SCI. An indication of CSI-RS within the 2^{nd}-stage SCI also triggers the reporting of CSI. As there is no sidelink physical channel corresponding to the uplink PUCCH, reporting of sidelink CSI is done by means of MAC CE signaling within a PSSCH. The signaling is limited to rank indication (rank one or two) and four-bit CQI. Thus, explicit sidelink PMI reporting is not supported. This is similar to the Type-I CSI reporting without PMI.

The following embodiments are described for enhancing frequency diversity on sidelink transmission. When a WTRU is configured for sidelink transmission it is configured with a sidelink resource pool which, among other things, defines the overall time/frequency resources that may be used for sidelink communication within a carrier.

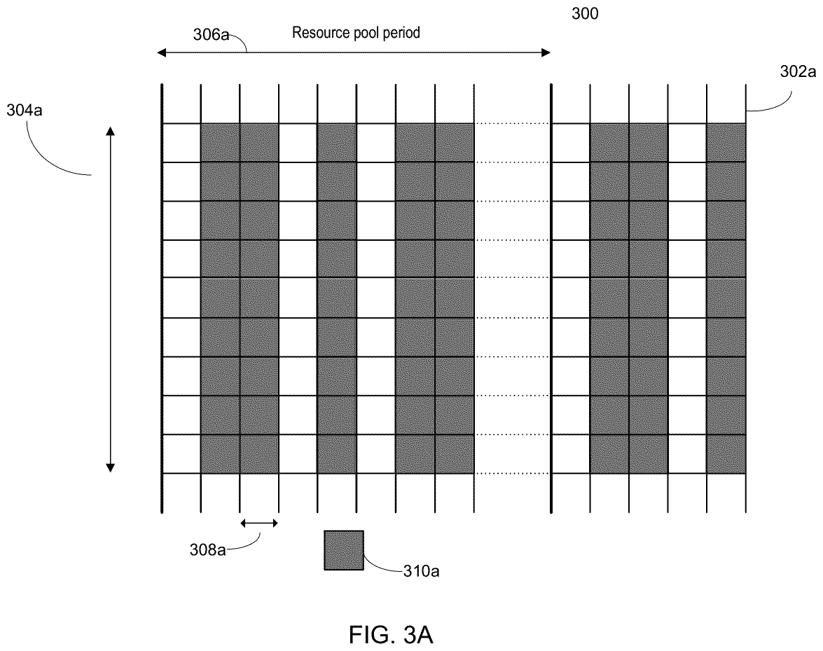

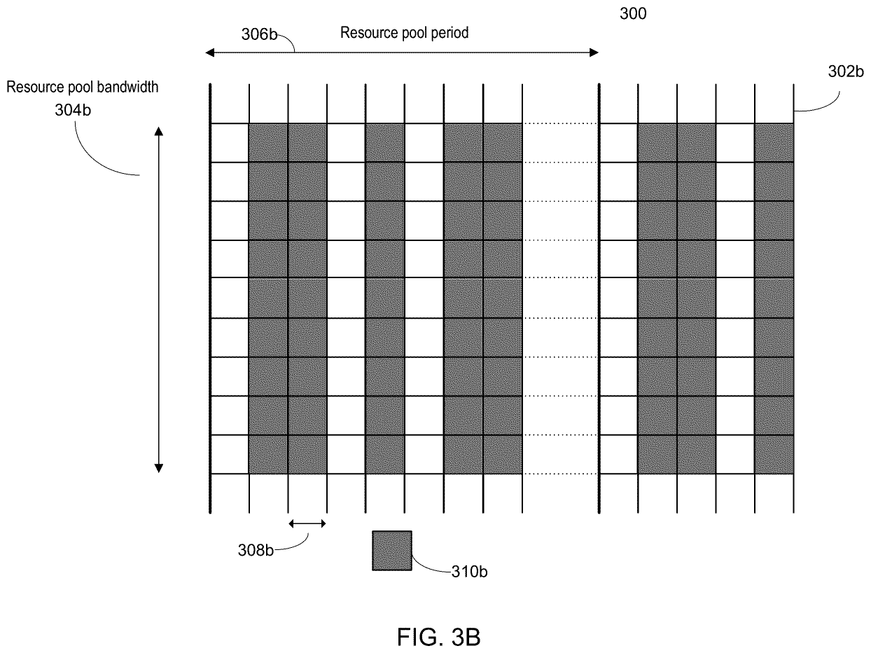

FIG. 3A is a nonlimiting example of a resource pool (RP) that may be allocated for sideling transmission. A RP has slot-based granularity. Slot 308a is representative of slots illustrated in a resource pool 302a. Sidelink slots are shaded as illustrated in 310a. A resource pool may include bandwidth 304a and a resource pool period 306a.

To further enhance the frequency diversity of sidelink communication in the presence of high-power narrowband interference, cross TxRP resource reservation is introduced. In an example embodiment, cross TxRPs resource reservation can be used to reserve resources on a different transmit resource pool for blind HARQ retransmissions (i.e., without HARQ feedback) to enhance frequency diversity. For example, a WTRU may receive SCI including information indicating at least one alternative Transmit Resource Pool (TxRP) different from the TxRP the SCI is transmitted on.

FIG. 3B is a nonlimiting example of an alternative or redundant resource pool (RP) different from the TxRP SCI information is transmitted. Slot 308b is representative of slots illustrated in 302b. Sidelink slots are shaded as illustrated in 310b. A resource pool such as alternative or redundant resource pool 302b may include bandwidth 304b and resource pool period 306b. A WTRU may receive SCI information via TxRP 302a, the SCI information may include information indicating at least one alternative Transmit Resource Pool (TxRP) 302b different from the TxRP (302a) the SCI is transmitted on.

In one embodiment, the field ‘Reservation resource pool index’, can be included in the SCI format 1-A to indicate an alternative TxRP (302b) the current SCI will identify and reserve resources. The remaining fields of SCI format 1-A may remain unchanged. If the field ‘Reservation resource pool index’ is not present, the TxRP (302a) that the current 1^{st}-stage SCI is transmitted on is implied. The field ‘Reservation resource pool index’ may have ┌log₂ maxNrofPoolID┐ bits.

In another example embodiment, a transmitting WTRU may use cross TxRPs resource reservation to reserve resources on a different TxRP for blind HARQ retransmissions (i.e., without HARQ feedback) or for HARQ retransmissions based on HARQ feedback. The alternative or redundant version to be applied for each transmission/retransmission is provided in the 2^{nd} stage SCI. A WTRU receiving the transmission/retransmission will combine the different redundancy versions of the same TB received from the different TxRPs (302a and 302b) within the same HARQ process.

In the case of HARQ feedback, where the PSFCH is associated with the current TB needs to be specified. For example, the TxRP the TB is transmitted/retransmitted can be the TxRP for the receiving WTRU to transmit the corresponding HARQ feedback. In an alternative embodiment, the TxRP where the first time a TB is transmitted, for example based on the new data indicator provided in the 2^{nd}-stage SCI, can be the TxRP for the receiving WTRU to transmit all HARQ feedback for the given TB. A WTRU implementing cross TxRP resource reservation on the sidelink should inform the corresponding peer WTRU of its capability to support cross TxRP resource reservation.

In an alternative embodiment, a transmitting WTRU may reserve resources on one or more alternative TxRP(s) (302b) in the 1^{st}-stage SCI by introducing a new SCI format (termed SCI format 1-B herein). For example, the following information is transmitted by means of the SCI format 1-B (assuming one reserved resource on a first alternative TxRP and one reserved resource on a second alternative Tx resource pool):

Priority (3 bits), where value ‘000’ of Priority field corresponds to priority value ‘1’, value ‘001’ of Priority field corresponds to priority value ‘2’, and so on.

Reservation resource pool frequency resource assignment

$$- ⌈ {log}_{2} ( \frac{{N}_{subChannelRP 1}^{SL} ( {N}_{subChannelRP 1}^{SL} + 1 )}{2} ) ⌉ bits$$

when the value of the higher layer parameter sl-MaxNumPerReserve is restricted to 2.

Reservation resource pool time resource assignment −5 bits when the value of the higher layer parameter sl-MaxNumPerReserve is restricted to 2.

Second reservation resource pool index −┌log₂ maxNrofPoolID┐ bits, when the value of the higher layer parameter sl-MaxNumPerReserve is restricted to 3.

Second reservation resource pool frequency resource assignment

$$- ⌈ {log}_{2} ( \frac{{N}_{subChannelRP 2}^{SL} ( {N}_{subChannelRP 2}^{SL} + 1 )}{2} ) ⌉ bits$$

when the value of the higher layer parameter sl-MaxNumPerReserve is restricted to 3, where here N_{subChannelRP2}^{SL} is the number of subchannels in the second resource pool.

Second reservation resource pool time resource assignment-5 bits when the value of the higher layer parameter sl-MaxNumPerReserve is restricted to 3.

Resource reservation period −┌log₂ N_{rsv_period}┐ bits, where N_{rsv_period} is the number of entries in the higher layer parameter sl-ResourceReservePeriodList, if higher layer parameter sl-MultiReserveResource is configured; 0 bit otherwise.

DMRS pattern −┌log₂ Nₚₐₜₜₑᵣₙ┐ bits, where Nₚₐₜₜₑᵣₙ is the number of DMRS patterns configured by higher layer parameter sl-PSSCH-DMRS-TimePatternList

2^{nd}-stage SCI format (2 bits) defined in Table 1.

Beta_offset indicator (2 bits) as provided by higher layer parameter sl-BetaOffsets2ndSCI as defined in Table 2.

Number of DMRS port (1 bit) as defined in Table 3.

Modulation and coding scheme (5 bits).

Additional MCS table indicator (1 bit) if one MCS table is configured by higher layer parameter sl-Additional-MCS-Table; (2 bits) if two MCS tables are configured by higher layer parameter sl-Additional-MCS-Table; (0 bit) otherwise

PSFCH overhead indication (1 bit) if higher layer parameter sl-PSFCH-Period=2 or 4; (0 bit) otherwise

Reserved—a number of bits as determined by the following:

In the case of resource allocation mode 1, the updated SCI format 1-A with ‘Reservation resource pool index’ or the newly introduced SCI format 1-B fields (replacing the SCI format 1-A fields) with ‘Reservation resource pool index’ and ‘Second reservation resource pool index’ can also be incorporated in the DCI format 3_0 for cross TxRP scheduling of PSSCH in one cell.

Cross TxRP scheduling may be configured among TxRPs with the same sl-SubchannelSize. If the cross-scheduled TxRPs do not have the same time-frequency structure (e.g., due to different configurations of sl-NumSubchannel, sl-PSCCH-Config, sl-PSSCH-Config or sl-PSFCH-Config), it is the responsibility of the transmitting UE to ensure that the time-frequency offsets indicated in cross TxRP scheduling SCI are feasible. If needed, additional higher layer resource pool configuration information required to facilitate cross TxRP scheduling, for example, a list of (sl-ResourcePoolID, sl-StartRB-Subchannel, sl-NumSubchannel) for the configured sl-TxPoolScheduling and a list of (sl-ResourcePoolID, sl-StartRB-Subchannel, sl-NumSubchannel) for the configured sl-TxPoolSelectedNormal, may be communicated during the PC5-RRC connection setup.

A WTRU should inform the peer sidelink WTRU (as part of UECapabilityInformationSidelink in PC5-RRC) and/or the network (as part of UECapabilityInformation in Uu-RRC) of its capability to support cross transmit resource pool resource reservation on the sidelink, as exemplified by the following information message.

| | | | FDD − TDD | FR1 − FR2 |
|---|---|---|---|---|
| Definitions for parameters | Per | M | DIFF | DIFF |
| sl-CrossTxPoolResource- | UE | No | No | No |
| Reservation | | | | |
| Indicates whether the UE | | | | |
| supports cross transmit | | | | |
| resource pool resource | | | | |
| reservation on the sidelink | | | | |

In another example embodiment, multiple redundant versions of codewords may be transmitted across a plurality of MIMO layers. A WTRU may determine a rank of a PSSCH based on CSI-RS, and determine to multiple redundancy versions of codewords simultaneously over multiple (nominally two) layers on PSSCH while using the same HARQ process. The process of transmitting multiple redundancy versions of codewords simultaneously over multiple (nominally two) layers on PSSCH may be referred to as PSSCH layer aggregation. A WTRU may apply PSSCH layer aggregation according to a channel quality when the determined rank is greater than 1. This approach improves HARQ efficiency.

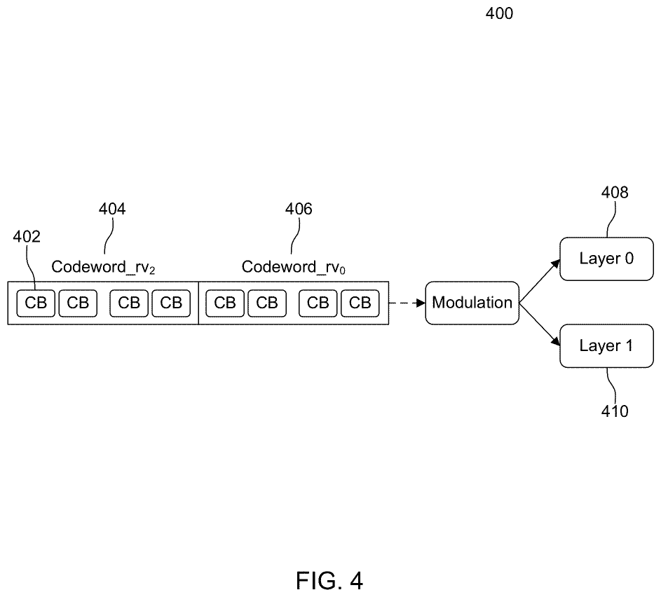

FIG. 4 illustrates an exemplary serial mapping of two redundant versions of codewords to two MIMO layers. The MIMO layers 408 and 410 correspond with a rank of 2. In an example embodiment, the channel bits from each code block (CB) 402 of the redundancy versions of codewords 404 and 406 are distributed evenly across MIMO layers 408 and 410. The SNR of each layer may be different, but the CBs across the layers will experience the same average SNR.

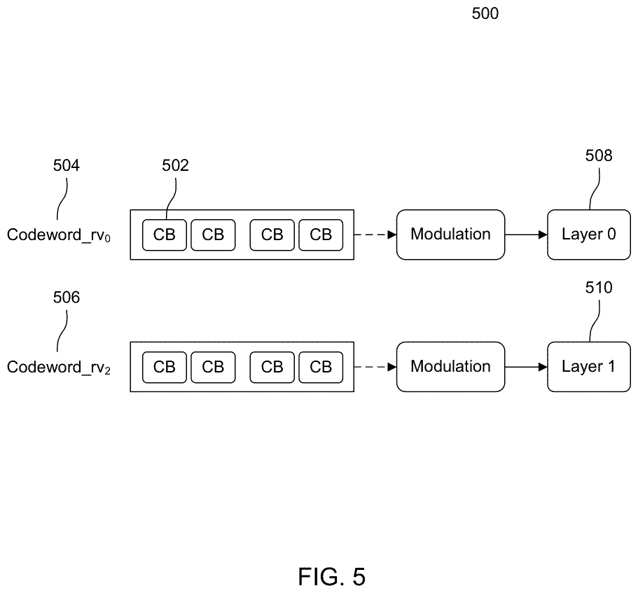

FIG. 5 illustrates an exemplary parallel mapping of two redundant versions of codewords to two MIMO layers. MIMO layers 508 and 510 correspond with a rank of 2. In another example embodiment, the codewords 504 and 506 associated with different redundancy versions are mapped to different MIMO layers 508 and 510. Codeword 504 is mapped to MIMO layer 508, and codeword 506 is mapped to MIMO layer 510. In this example embodiment, the codewords associated with different redundancy versions may experience different SNRs.

In the example embodiments illustrated in FIGS. 4 and 5, a WTRU may transmit an indication to apply MIMO layer aggregation via SCI signaling. PSSCH layer aggregation can be triggered by the WTRU when high-power narrowband interference, for example RADAR or an intentional/jammer signal, measured by the transmitting WTRU (e.g., during the sensing window) or reported by a receiving WTRU (e.g., via an extended CSI report) exceeds a configured/preconfigured threshold. For example, a set of thresholds may be defined based on the MCS or modulation order. The transmitting WTRU may then select the appropriate threshold based on the MCS or modulation order used for the PSSCH. And in other examples, the threshold may be selected based on characteristics of the data, characteristics of the service and/or characteristics of the device, for example the QoS of the data being transmitted on the PSSCH, the service being provided to the device, and/or the device type.

PSSCH layer aggregation can also be triggered to further enhance the reliability and hence reduce the latency of the PSSCH transmission in nominal deployment environments, irrespective of the high-power narrowband interference, for example to better support the URLLC service on the sidelink. In addition, PSSCH layer aggregation can be applied to unicast, groupcast, or broadcast sidelink transmissions.

The transmitting WTRU may trigger PSSCH layer aggregation and inform the receiving WTRU of the PSSCH layer aggregation using the SCI, this may be done in both resource allocation mode 1 and mode 2. For example, a ‘layer aggregation enabled/disabled indicator’ bit can be defined in SCI format 2-A, format 2-B and format 2-C. When the ‘layer aggregation enabled/disabled indicator’ is set to 1 and if the sidelink MIMO rank is equal to 2 or greater, PSSCH layer aggregation will be applied, and the redundancy versions may be given by 7 (with rv_{id} being the ‘Redundancy version’ field in SCI format 2-A, 2-B and 2-C).

TABLE 7

| rv_{id} indicated by the SCI | rv_{id} to be applied to m^{th} MIMO layer (rank = 2) | |
|---|---|---|
| scheduling the PSSCH | m = 0 | m = 1 |
| 0 | 0 | 2 |
| 2 | 2 | 3 |
| 3 | 3 | 1 |
| 1 | 1 | 0 |

When the receiving UE receives the SCI signaling indicating the use of layer aggregation in PSSCH, the UE extracts multiple redundancy versions of each code block from different MIMO layers and performs HARQ combing from the multiple redundancy versions of each code block. Based on the decoding results, the UE then reports Ack/Nack or Nack only feedback of the received transport blocks to the transmitting UE on the PSFCH channel, if configured.

UE should inform the peer sidelink UE (as part of UECapabilityInformation Sidelink in PC5-RRC) and/or the network (as part of UECapabilityInformation in Uu-RRC) of its capability to support PSSCH layer aggregation, as exemplified by the following information message.

| | | | FDD − TDD | FR1 − FR2 |
|---|---|---|---|---|
| Definitions for parameters | Per | M | DIFF | DIFF |
| sl-PsschLayerAggregation | WTRU | No | No | No |
| Indicates whether the UE supports PSSCH | | | | |
| layer aggregation on the sidelink | | | | |

In another example embodiment, a WTRU may enhance frequency diversity on sidelink transmission by allocating two or more exceptional TxRPs that are located distally from each other in a frequency domain. Currently, a single exceptional TxRP can be configured for the case when sidelink WTRUs in network coverage do not have stable network connections. These situations include when a WTRU is in a transition from idle to connected mode, when a WTRU experiences a radio link failure (RLF) or a handover, or when a WTRU is changing between different configured TxRPs where the WTRU has not any stable configuration of the transmission resource pool. The exceptional resource pool may only be for temporary usage. Resource allocation in an exceptional resource pool is based on a random selection of resources. WTRUs receive the configuration of exceptional resource pools through the broadcasting of the serving cell or some dedicated signaling. All WTRUs are mandated to monitor the exceptional resource pool in addition to the reception resource pool to enable the communication for WTRUs which use these resources in exceptional cases. The use of exceptional TxRP in such situations aids in improving service continuity.

However, in the presence of high-power narrowband interference, the interference bandwidth may overlap with that of the exceptional TxRP. To mitigate the impact of high-power narrowband interference on the exceptional TxRP, a second exceptional TxRP (illustrated below as sl-TxPool2ndExceptional) can be configured. The frequency locations of the first and second exceptional TxRP should be far apart within the SL BWP such that if one exceptional TxRP is corrupted by the high-power narrowband interferer, the second exceptional TxRP may not be affected. In the absence of high-power narrowband interferer, one exceptional TxRP may be randomly selected between the two configured exceptional TxRPs each time a TB needs to be transmitted over the exceptional TxRP to achieve load balancing.

A WTRU should inform the peer sidelink WTRU (as part of UECapabilityInformationSidelink in PC5-RRC) and/or the network (as part of UECapabilityInformation in Uu-RRC) of its capability to support two exceptional TxRPs, as exemplified by the following information message.

| | | | FDD − TDD | FR1 − FR2 |
|---|---|---|---|---|
| Definitions for parameters | Per | M | DIFF | DIFF |
| sl-DualExceptionalTxPools | WTRU | No | No | No |
| Indicates whether the UE supports two | | | | |
| exceptional transmit resource pools | | | | |
| on the sidelink | | | | |

In an example embodiment, a WTRU may allocate two or more exceptional TxRPs located distally from each other in a frequency domain. When detecting a narrowband interferer, the WTRU may select at least one of the two or more exceptional TxRPs each time a TB is to be transmitted, select randomly resources in the selected at least one of the two or more exceptional TxRPs, and transmit each of the TB via the randomly selected resources. As described above, the WTRU should inform a peer sidelink WTRU and a corresponding network, either alone or in combination, of the transmitting WTRUs capability to support two or more TxRPs. In an alternative embodiment, a WTRU may select at least one of the two or more exceptional TxRPs based on a detected frequency of the detected narrowband interferer or selecting randomly at least one of the two or more exceptional TxRPs.

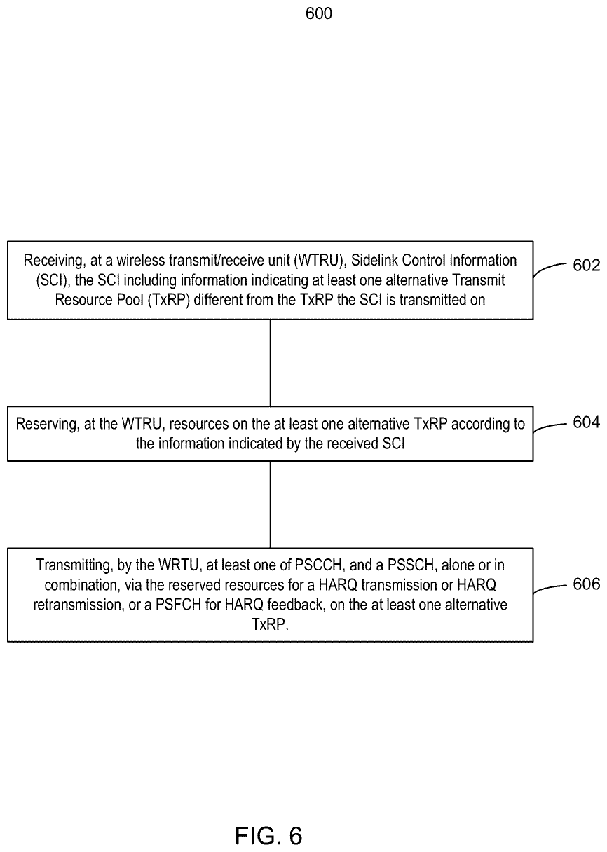

FIG. 6 is a flow diagram of an exemplary process for performing PSSCH transmission. At 602 a WTRU receives SCI, where the SCI including information indicating at least one alternative TxRP different from the TxRP where the SCI is transmitted. The WTRU, at 604, reserving resources on the at least one alternative TxRP according to the information indicated by the received SCI. In an example embodiment, the field ‘Reservation resource pool index’, can be included in the SCI format 1-A to indicate the alternative TxRP the current SCI will reserve resources. In another example embodiment, a transmitting WTRU may reserve resources on the at least one alternative TxRP by introducing a new SCI format (SCI format 1-B herein).

At 606, the WTRU transmits at least one of: a Physical Sidelink Control Channel (PSCCH), and a Physical Sidelink Shared Channel (PSSCH), alone or in combination, via the reserved resources for a Hybrid Automatic Repeat Request (HARQ) transmission or HARQ retransmission, or a Physical Sidelink Feedback Channel (PSFCH) for HARQ feedback, on the at least one alternative TxRP.

In an embodiment, a WTRU may indicate the at least one alternative TxRP different from the TxRP the SCI is transmitted on in at least one SCI format field. In a further embodiment, alone or in combination with the preceding embodiments the method may further comprise implementing a cross TxRP resource reservation for reserving resources for blind HARQ retransmissions or for HARQ retransmissions based on HARQ feedback, and indicating, via additional SCI information carried on the PSSCH, resources for a redundancy version of the HARQ transmission or retransmission.

The method may further comprise, alone or in combination with any of the above embodiments, combining at a destination WRTU, different redundancy versions of a same Transport Block (TB) received from different TxRPs within a same HARQ process. In addition, the method may comprise, alone or in combination with any of the above embodiments, informing a peer WTRU and a corresponding network, alone or in combination, of a capability of the WTRU to support cross TxRP reservation on a sidelink.

In an alternative embodiment, the method may further comprise determining a rank of PSSCH transmission based on a Channel State Information (CSI)-Reference Signal (RS), and determining to apply PSSCH layer aggregation according to a channel quality when the determined rank is greater than 1. The method may further comprise, in combination with alternative embodiment, by the WTRU in SCI signaling, an indication to apply the PSSCH layer aggregation. In addition, the method in the alternative embodiment may comprise transmitting, by the WTRU, a plurality of redundant versions of codewords across a plurality of MIMO layers, the plurality of MIMO layers corresponding to the determined rank. This may further include where channel bits from each Code Block (CB) of the plurality of redundant versions of the codewords are distributed evenly across the plurality of MIMO layers or wherein CBs for different redundancy versions of the codewords are mapped to different layers of the plurality of MIMO layers.

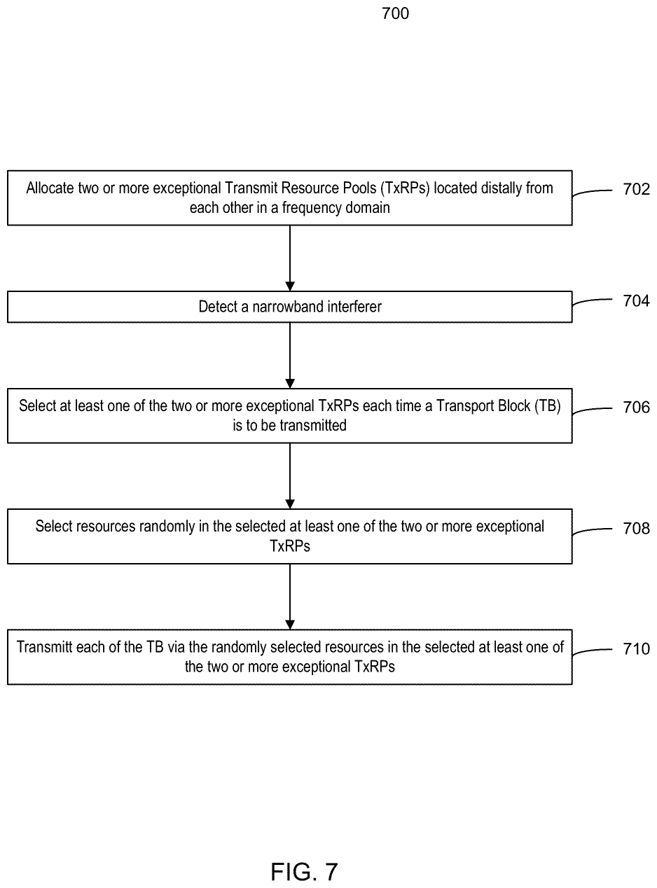

FIG. 7 is a flow diagram of an exemplary process for enhancing frequency diversity on sidelink transmission. The process may be performed by a WTRU. At 702, two or more exceptional TxRPs are allocated. The two or more exceptional TxRPs are located far apart from each other in the frequency domain of a SL BWP. By being located far apart from each other in the frequency domain of the SL BWP, if one exceptional TxRPs is degraded by a high-power narrowband interferer, another exceptional TxRP is not likely to be affected and may be used to sustain the transmission over the other exceptional TxRP.

A narrowband interferer is detected at 704. At 706, each time a TB is to be transmitted at least one of the two or more exceptional TxRPs is selected, and at 708 resources are randomly selected in the at least one of the two or more exceptional TxRPs selected at 706. In the absence of high-power narrowband interferer, an exceptional TxRP may be randomly selected between the two configured exceptional TxRPs each time a TB needs to be transmitted over the exceptional TxRP to achieve load balancing. Each of the TB is transmitted via the randomly selected resources in the selected at least one of the two or more exceptional TxRPs at 710. The method may include a WTRU informing a peer link WTRU and network, either alone or in combination, of its capability to support two or more TxRPs. The method may further comprise, selecting at least one of the two or more exceptional TxRPs based on a detected frequency of the detected narrowband interferer or selecting randomly at least one of the two or more exceptional TxRPs. Selecting at least one of the two or more exceptional TxRPs based on a detected frequency may ensure that at least one of the two or more exceptional TxRPs will include resources that are not affected by the narrowband interferer.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method of performing Physical Sidelink Shared Channel (PSSCH) transmission, the method comprising:
receiving, at a wireless transmit/receive unit (WTRU), Sidelink Control Information (SCI), the SCI including information indicating at least one alternative Transmit Resource Pool (TxRP) different from the TxRP the SCI is transmitted on;
reserving, at the WTRU, resources on the at least one alternative TxRP according to the information indicated by the received SCI; and
transmitting, by the WRTU, at least one of: a Physical Sidelink Control Channel (PSCCH), and a Physical Sidelink Shared Channel (PSSCH), alone or in combination, via the reserved resources for a Hybrid Automatic Repeat Request (HARQ) transmission or HARQ retransmission, or a Physical Sidelink Feedback Channel (PSFCH) for HARQ feedback, on the at least one alternative TxRP.

2. The method according to claim 1, further comprising indicating, by the WRTU, the at least one alternative TxRP different from the TxRP the SCI is transmitted on in at least one SCI format field.

3. The method according to claim 1, further comprising:
implementing a cross TxRP resource reservation for reserving resources for blind HARQ retransmissions or for HARQ retransmissions based on HARQ feedback; and
indicating, via additional SCI information carried on the PSSCH, resources for a redundancy version of the HARQ transmission or retransmission.

4. The method according to claim 3, further comprising combining at a destination WRTU, different redundancy versions of a same Transport Block (TB) received from different TxRPs within a same HARQ process.

5. The method according to claim 1, further comprising informing a peer WTRU and a corresponding network, alone or in combination, of a capability of the WTRU to support cross TxRP reservation on a sidelink.

6. The method according to claim 1, further comprising:
determining a rank of PSSCH transmission based on a Channel State Information (CSI)-Reference Signal (RS); and
determining to apply PSSCH layer aggregation according to a channel quality when the determined rank is greater than 1.

7. The method according to claim 6, further comprising transmitting, by the WTRU in SCI signaling, an indication to apply the PSSCH layer aggregation.

8. The method according to claim 6, further comprising transmitting, by the WTRU, a plurality of redundant versions of codewords across a plurality of Multiple Input Multiple Output (MIMO) layers, the plurality of MIMO layers corresponding to the determined rank.

9. The method according to claim 8, wherein channel bits from each Code Block (CB) of the plurality of redundant versions of the codewords are distributed evenly across the plurality of MIMO layers or wherein CBs for different redundancy versions of the codewords are mapped to different layers of the plurality of MIMO layers.

10. A wireless transmit/receive unit (WTRU) comprising:
a receiver configured to receive Sidelink Control Information (SCI), the SCI including information indicating at least one alternative Transmit Resource Pool (TxRP) different from the TxRP the SCI is transmitted on;
a processor configured to reserve resources on the at least one alternative TxRP according to the received SCI; and
a transmitter configured to transmit at least one of: a Physical Sidelink Control Channel (PSCCH), and a Physical Sidelink Shared Channel (PSSCH), alone or in combination, via the reserved resources for a Hybrid Automatic Repeat Request (HARQ) transmission or HARQ retransmission, or a Physical Sidelink Feedback Channel (PSFCH) for an HARQ feedback on the at least one alternative TxRP.

11. The WTRU according to claim 10, wherein at least one field in a SCI format contains the information indicating the at least one alternative TxRP different from the TxRP the SCI is transmitted on.

12. The WTRU according to claim 10, wherein the processor is further configured to:
implement cross TxRP resource reservation for reserving resources for blind HARQ retransmissions or for HARQ retransmissions based on HARQ feedback; and
indicate, via additional SCI information carried on the PSSCH, resources for a redundancy version of the HARQ transmission or retransmission.

13. The WTRU according to claim 12, wherein the processor is further configured to combine different redundancy versions of a same Transport Block (TB) received from different TxRPs within a same HARQ process.

14. The WTRU according to claim 10, wherein the WTRU is configured to inform a peer sidelink WRTU and a corresponding network, either alone or in combination, of its capability to support cross TxRP reservation on a sidelink.

15. The WTRU according to claim 10, wherein the processor is further configured to:
determine a rank of a PSSCH transmission based on a Channel State Information (CSI)-Reference Signal (RS); and
determine to apply PSSCH layer aggregation according to a channel quality when the determined rank is greater than 1.

16. The WTRU according to claim 15, wherein the WTRU is configured to transmit, in SCI signaling, an indication to apply the PSSCH layer aggregation.

17. The WTRU according to claim 15, wherein the WTRU transmits a plurality of redundant versions of codewords across a plurality of Multiple Input Multiple Output (MIMO) layers, the plurality of MIMO layers corresponding to the determined rank.

18. The WTRU according to claim 17, wherein channel bits from each Code Block (CB) of the plurality of redundant versions of the codewords are distributed evenly across the plurality of MIMO layers or wherein CBs for different redundancy versions of the codewords are mapped to different layers of the plurality of MIMO layers.

19. A method of enhancing frequency diversity on sidelink transmission, the method comprising:
allocating two or more exceptional Transmit Resource Pools (TxRPs) located distally from each other in a frequency domain;
detecting a narrowband interferer;
selecting at least one of the two or more exceptional TxRPs each time a Transport Block (TB) is to be transmitted;
selecting resources randomly in the selected at least one of the two or more exceptional TxRPs;
transmitting each of the TB via the randomly selected resources in the selected at least one of the two or more exceptional TxRPs; and
informing a peer sidelink wireless transmit/receive unit (WTRU) and a corresponding network, either alone or in combination, of a transmitting WTRUs capability to support two or more TxRPs.

20. The method according to claim 19, further comprising selecting at least one of the two or more exceptional TxRPs based on a detected frequency of the detected narrowband interferer or selecting randomly at least one of the two or more exceptional TxRPs.
